(19) United States
(12) Patent Application Publication
(10) Pub. No.: US 2020/0144848 A1
(43) Pub. Date: May 7, 2020

(54) CIGAR LIGHTER HAVING WIRELESS ELECTRICITY RECEIVING FUNCTION AND PORTABLE POWER SUPPLY DEVICE HAVING WIRELESS ELECTRICITY RECEIVING FUNCTION

(71) Applicant: NEWVASTEK CO., LTD., Taipei City (TW)

(72) Inventors: Ming-Liang Fang, TAIPEI CITY (TW); Sheng-Kuan Chen, TAIPEI CITY (TW); Chih-Hao Chuang, TAIPEI CITY (TW)

(73) Assignee: NEWVASTEK CO., LTD., TAIPEI CITY (TW)

(21) Appl. No.: 16/675,664

(22) Filed: Nov. 6, 2019

(30) Foreign Application Priority Data
Nov. 7, 2018 (TW) 107139578

(51) Int. Cl. H02J 7/02; H02J 50/12; H02J 7/00

(52) U.S. Cl. CPC H02J 7/025; H02J 2007/0062; H02J 7/0052; H02J 50/12

(57) ABSTRACT

A cigar lighter having a wireless electricity receiving function includes a housing, a first electric-conductor, a second electric-conductor, a receive coil, a rectifier module, a voltage adjustment module, and an output end. The first electric-conductor and the second electric-conductor protrude from the housing to be in contact with a first electrode terminal and a second electrode terminal of a connector. The receive coil is located on the housing. The rectifier module is located in a chamber of the housing, and the rectifier module is electrically connected to the receive coil. The voltage adjustment module is located in the chamber and is electrically connected to the first electric-conductor, the second electric-conductor, and the rectifier module. The output end is located at one end of the housing and is electrically connected to the voltage adjustment module. In addition, a portable power supply device having a wireless electricity receiving function is also provided.

### CROSS-REFERENCE TO RELATED APPLICATION

This non-provisional application claims priority under 35 U.S.C. § 119(a) to Patent Application No. 107139578 filed in Taiwan, R.O.C. on Nov. 7, 2018, the entire contents of which are hereby incorporated by reference.

### BACKGROUND

### Technical Field

The present invention relates to wireless electricity receiving technologies, and in particular, to a cigar lighter having a wireless electricity receiving function and a portable power supply device having a wireless electricity receiving function.

### Related Art

In recent years, with rising of portable electronic devices (such as smartphones, tablets, and notebook computers), related art, including wireless charging technologies, also vigorously grows. By means of the wireless charging technology, a portable electronic device can be charged without using a transmission cable between the portable electronic device and a power supply end (such as a wireless charging station), that is, electric power is transmitted in a wireless manner. In addition to the fact that the wireless charging technology can be applied to the portable electronic device, smart household appliance and vehicular wireless charging solutions and the like are provided. Current wireless charging standards mainly include the Qi wireless charging standard released by Wireless Power Consortium (WPC) and the AirFuel wireless charging standard released by AirFuel Alliance, a merger between the Alliance for Wireless Power (A4WP) and the Power Matters Alliance (PMA).

### SUMMARY

If a wireless charging manner of a wireless charging station uses a wireless charging standard, a portable electronic device of a user also needs to have a wireless electricity receiving chip that matches the wireless charging standard, so that the portable electronic device can be charged. Therefore, it is inconvenient in use.

In addition, during manufacturing, not all electronic devices are configured with wireless electricity receiving chips to be capable of receiving wireless electricity generated by a wireless charging station. Because some electronic devices of relatively old types do not have the wireless electricity receiving chip, they cannot use the wireless charging technology.

In view of this, an embodiment of the present invention provides a cigar lighter having a wireless electricity receiving function, including a housing, a first electric-conductor, a second electric-conductor, a receive coil, a rectifier module, a voltage adjustment module, and an output end. The housing has a first end, a second end, and a chamber. The first end is opposite to the second end. The first electric-conductor is located in the chamber and protrudes from the first end. The second electric-conductor is located in the chamber and protrudes from one side of the housing. The receive coil is located on the housing. The receive coil is adapted to generate an alternating current after receiving a magnetic field. The rectifier module is located in the chamber, and the rectifier module is electrically connected to the receive coil. The rectifier module is adapted to receive and convert the alternating current into a first direct current. The voltage adjustment module is located in the chamber, and the voltage adjustment module is electrically connected to the first electric-conductor, the second electric-conductor, and the rectifier module. The voltage adjustment module is adapted to: selectively receive an external direct current by using the first electric-conductor and the second electric-conductor, and convert the external direct current into a second direct current whose voltage is different from that of the external direct current; or receive the first direct current from the rectifier module and convert the first direct current into the second direct current whose voltage is different from that of the first direct current. The output end is located at the second end, and the output end is electrically connected to the voltage adjustment module to output the second direct current.

In one or more embodiments, the voltage adjustment module of the cigar lighter has a fast charge circuit, and the fast charge circuit is a direct current voltage/current adjustment circuit having various fast charge protocol functions.

In one or more embodiments, the receive coil is disposed around the second end.

In one or more embodiments, a surface of the housing has an annular groove, and the receive coil is disposed in the annular groove.

In one or more embodiments, the cigar lighter further includes an insulation cover member, and the insulation cover member is disposed on the housing to cover the receive coil.

In one or more embodiments, the rectifier module of the cigar lighter is a reverse blocking circuit.

Further, another embodiment of the present invention provides a portable power supply device having a wireless electricity receiving function, including a housing, a battery, a receive coil, a rectifier module, a voltage adjustment module, and an output end. The battery is located in the housing. The receive coil is disposed on the housing, and the receive coil is adapted to generate an alternating current after receiving a magnetic field. The rectifier module is located in the housing, and the rectifier module is electrically connected to the receive coil. The rectifier module is adapted to receive and convert the alternating current into a first direct current. The voltage adjustment module is located in the housing, and the voltage adjustment module is electrically connected to the battery and the rectifier module. The voltage adjustment module is adapted to: selectively receive an internal direct current from the battery and convert the internal direct current into a second direct current; or receive the first direct current from the rectifier module and convert the first direct current into the second direct current, where a voltage of the internal direct current is different from a voltage of the second direct current, and a voltage of the first direct current is different from the voltage of the second direct current. The output end is electrically connected to the voltage adjustment module to output the second direct current.

In one or more embodiments, the voltage adjustment module of the portable power supply device has a fast charge circuit, and the fast charge circuit is a direct current voltage/current adjustment circuit having various fast charge protocol functions.

In one or more embodiments, the rectifier module of the portable power supply device is a reverse blocking circuit.

In one or more embodiments, the voltage adjustment module is adapted to: after converting the first direct current into the second direct current, first store the second direct current to the battery, and then output the second direct current from the battery to the output end.

In one or more embodiments, when a voltage of the battery is less than a rated voltage, the voltage adjustment module does not receive the internal direct current but receives and converts the first direct current into the second direct current.

In conclusion, the cigar lighter and the portable power supply device in one or more embodiments of the present invention can first convert a magnetic field into an alternating current through electromagnetic induction, and then further convert the alternating current into a direct current for outputting. In this way, when there is a wireless charging station that can provide a magnetic field, a user may connect a portable electronic device to the cigar lighter or the portable power supply device according to one or more embodiments of the present invention by using a transmission cable to receive a direct current, to charge the portable electronic device. In addition, in one or more embodiments, the voltage adjustment module satisfies a fast charge protocol because the voltage adjustment module has the fast charge circuit, to fast charge the portable electronic device. Moreover, the rectifier module may further include the reverse blocking circuit, to avoid damages to an internal part caused by the current entering the device in a reverse direction.

Further, in one or more embodiments of the portable power supply device of the present invention, the voltage adjustment module is adapted to: after converting the first direct current into the second direct current, first store the second direct current to the battery, and then output the second direct current from the battery to the output end. In addition, in one or more embodiments of the portable power supply device of the present invention, when the voltage of the battery is less than the rated voltage, the voltage adjustment module does not receive the internal direct current but receives and converts the first direct current into the second direct current, and transmits the second direct current to the output end to charge the portable electronic device.

### BRIEF DESCRIPTION OF THE DRAWINGS

FIG. 1A is a three-dimensional view of a first embodiment of a cigar lighter having a wireless electricity receiving function according to the present invention;

FIG. 1B is a partially enlarged view of an exemplary embodiment of a connector adapted to connect to the cigar lighter in FIG. 1A;

FIG. 2 is a circuit block diagram of the first embodiment of the cigar lighter having a wireless electricity receiving function according to the present invention;

FIG. 3 is an exemplary circuit distribution diagram of a rectifier module;

FIG. 4 is a partial exploded view of a second embodiment of a cigar lighter having a wireless electricity receiving function according to the present invention;

FIG. 5 is a three-dimensional view of an exemplary embodiment of a portable power supply device having a wireless electricity receiving function according to the present invention; and

FIG. 6 is a circuit block diagram of an exemplary embodiment of a portable power supply device having a wireless electricity receiving function according to the present invention.

### DETAILED DESCRIPTION

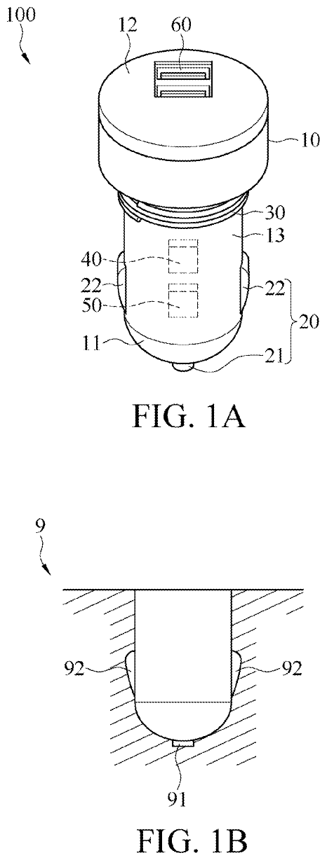

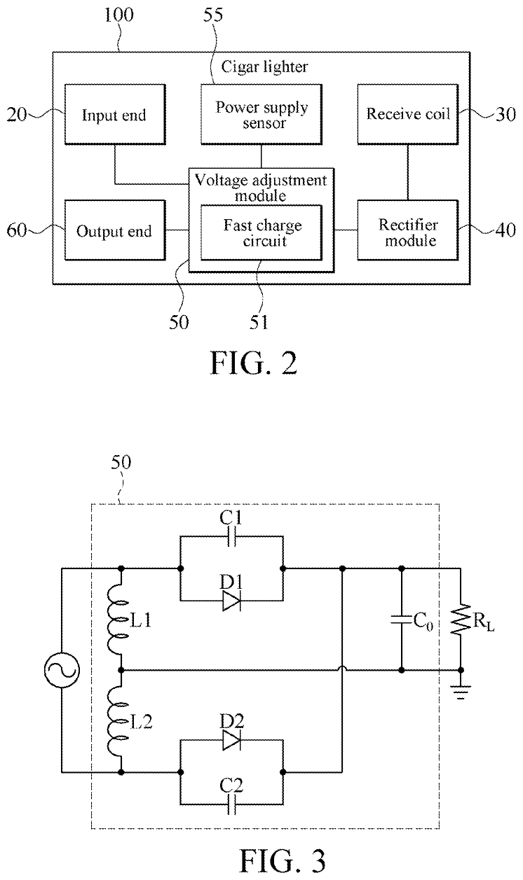

FIG. 1A, FIG. 1B, and FIG. 2 are respectively a three-dimensional view of a first embodiment of a cigar lighter having a wireless electricity receiving function (which is referred to as a cigar lighter 100 for short below) according to the present invention, a partially enlarged view of an exemplary embodiment of a connector 9, and a circuit block diagram of the first embodiment of the cigar lighter 100. As shown in FIG. 1A, FIG. 1B, and FIG. 2, the cigar lighter 100 includes a housing 10, an input end 20, a receive coil 30, a rectifier module 40, a voltage adjustment module 50, and an output end 60.

The cigar lighter 100 in one or more embodiments of the present invention is adapted to electrically connect to the connector 9 of a transportation, and the connector 9 is electrically connected to a power supply of the transportation (for example, but is not limited to a vehicle storage battery). In this way, the cigar lighter 100 may receive an external direct current supplied by the power supply. In addition, when the output end 60 is connected to a portable electronic device by using a transmission cable, the external direct current is provided to the portable electronic device. Herein, the transportation may be a vehicle but is not limited thereto. The transportation may alternatively be a locomotive or a transportation of another type. In addition, the portable electronic device herein may be a smartphone but is not limited thereto. The portable electronic device may alternatively be a notebook computer, a tablet computer, a digital camera, or the like.

The cigar lighter 100 in one or more embodiments is further adapted to receive a magnetic field to supply power to the portable electronic device by using the transmission cable. After the cigar lighter 100 receives the magnetic field generated by a wireless charging station, the cigar lighter 100 may convert the magnetic field into a direct current and output the direct current to the portable electronic device by using the transmission cable to charge the portable electronic device.

Referring to FIG. 1A, FIG. 1B, and FIG. 2, the housing 10 has a first end 11 and a second end 12, and the first end 11 is opposite to the second end 12. For example, in this embodiment, the housing 10 is of a rod-shaped structure, and the first end 11 and the second end 12 are two opposite ends of the rod-shaped structure. However, the present invention is not limited thereto. In some embodiments, the housing 10 may be of a U-shaped structure, and the first end 11 and the second end 12 are located on a same side of the U-shaped structure. In addition, in this embodiment, the housing 10 is made of an insulation material (for example, but is not limited to plastic), to prevent a magnetic field generated by the receive coil 30 from interfering operation of an internal electronic part (such as the rectifier module 40 or the voltage adjustment module 50) of the cigar lighter 100. However, the present invention is not limited thereto. In some embodiments, only a part of the housing 10 that corresponds to the receive coil 30 may be made of an insulation material, and another part of the housing 10 may be made of an insulation material but is not limited thereto.

Referring to FIG. 1A, FIG. 1B, and FIG. 2, the input end 20 includes a first electric-conductor 21 and a second electric-conductor 22 that are located in a chamber 13 of the housing 10. The first electric-conductor 21 protrudes from the first end 11 to be in contact with a first electrode terminal 91 of the connector 9. The second electric-conductor 22 protrudes from one side of the housing 10 to be in contact with a second electrode terminal 92 of the connector 9. In this way, the first electric-conductor 21, the first electrode terminal 91, the second electric-conductor 22, and the second electrode terminal 92 form an enclosed loop, so that the external direct current provided by the power supply of the transportation can be provided to the output end 60 for use. In this embodiment, there are two second electric-conductors 22 and two second electrode terminals 92. However, the present invention is not limited thereto. In some embodiments, there may be one or at least three second electric-conductors 22 and one or at least three second electrode terminals 92.

Referring to FIG. 1A, FIG. 1B, and FIG. 2, the receive coil 30 is located on the housing to generate an alternating current after receiving the magnetic field from the wireless charging station. In one or more embodiments, as shown in FIG. 1, the receive coil 30 is disposed around the second end 12, that is, the second end 12 passes through the receive coil 30. However, the present invention is not limited thereto. The receive coil 30 may alternatively be merely disposed on the housing 10 instead of being disposed around the housing 10.

The rectifier module 40 is located in the chamber 13 and is electrically connected to the receive coil 30. The rectifier module 40 is adapted to: receive the alternating current from the receive coil 30 and convert the alternating current into a first direct current. In other words, the rectifier module 40 may be a rectifier circuit and can convert the alternating current into the direct current. Specifically, two ends of the receive coil 30 may be inserted into the housing 10 and electrically connected to the rectifier module 40.

Referring to FIG. 1 and FIG. 2, the voltage adjustment module 50 is also located in the chamber 13 and is electrically connected to the first electric-conductor 21, the second electric-conductor 22, and the rectifier module 40. The voltage adjustment module 50 is adapted to: selectively receive the external direct current by using the first electric-conductor 21 and the second electric-conductor 22, and convert the external direct current into a second direct current whose voltage is different from that of the external direct current; or receive the first direct current from the rectifier module 40 and convert the first direct current into the second direct current whose voltage is different from that of the first direct current. In other words, the voltage adjustment module 50 may be a voltage adjustment circuit and is adapted to change the voltage. For example, the voltage of the external direct current may be 12 V, the voltage of the first direct current may be 12 V, and the voltage of the second direct current may be 5 V.

Referring to FIG. 1A, FIG. 1B, and FIG. 2, the output end 60 is located at the second end 12. The output end 60 is electrically connected to the voltage adjustment module 50 to output the second direct current. The output end 60 may be, for example, but is not limited to a USB (universal serial bus) interface. The output end 60 may alternatively be another transmission interface such as an HDMI, a micro HDMI, or a micro USB interface, and may be adapted to connect to the portable electronic device.

According to the cigar lighter 100 in one or more embodiments of the present invention, after the receive coil 30 receives the magnetic field from the wireless charging station, the receive coil 30 converts the magnetic field into the alternating current through electromagnetic induction, and then the rectifier module 40 converts the alternating current into the first direct current. Then, the voltage adjustment module 50 converts the first direct current into the second direct current whose voltage is different from that of first direct current. Finally, the second direct current is output by using the output end 60. In this way, the portable electronic device may be connected to the output end 60 by using the transmission cable, to receive the second direct current from the cigar lighter 100 for being charged.

Referring to FIG. 2 again, based on foregoing descriptions, the voltage adjustment module 50 selectively receives the external direct current by using the first electric-conductor 21 and the second electric-conductor 22 and converts the external direct current into the second direct current; or receives the first direct current from the rectifier module 40 and converts the first direct current into the second direct current. Specifically, in an embodiment, the cigar lighter 100 further includes a power supply sensor 55 electrically connected to the voltage adjustment module 50 and adapted to sense whether the first electric-conductor 21 and the second electric-conductor 22 are respectively electrically connected to the first electrode terminal 91 and the second electrode terminal 92 to receive the external direct current. If yes, the cigar lighter 100 receives the external direct current by using the first electric-conductor 21 and the second electric-conductor 22 and converts the external direct current into the second direct current. In this way, the cigar lighter 100 may first sense, by using the power supply sensor 55, whether the cigar lighter 100 is connected to the power supply, and then determine, according to a result, to receive the external direct current or the first direct current.

In one or more embodiments, referring to FIG. 2 again, the voltage adjustment module 50 has a fast charge circuit 51, and the fast charge circuit 51 is a direct current voltage/current adjustment circuit having various fast charge protocol functions. For example, the fast charge circuit 51 may be a high-voltage fast charge circuit, a low-voltage fast charge circuit, or a voltage/current boost circuit. In other words, the fast charge circuit 51 may satisfy a fast charge protocol, so that the fast charge circuit 51 rapidly transmits the second direct current output from the output end 60 to the portable electronic device through voltage boosting, current boosting, or selective voltage/current boosting, to fast charge the portable electronic device.

FIG. 3 is an exemplary circuit distribution diagram of the rectifier module 50. In one or more embodiments, the rectifier module 50 may be a circuit shown in FIG. 3 and has a reverse blocking function; or the rectifier module 50 may include a circuit shown in FIG. 3. Specifically, when a user performs rectification by using the rectifier module 50 shown in FIG. 3, during an alternating current positive half-cycle, an alternating current power supply positive half-cycle output end outputs a current, first conversion is performed on the current by using a first rectifier component D1 and a first resonant unit C1 connected in parallel to the first rectifier component D1, then the current flows through a voltage stabilization component C₀ and a load component R_{L} and flows through a first splitting component L1 and a second splitting component L2, so that half of the current flows back to a negative half-cycle output end, and the other half of the current flows to the first rectifier component D1 again for second conversion. Similarly, during an alternating current negative half-cycle, the alternating current negative half-cycle output end outputs a current, first conversion is performed on the current by using a second rectifier component D2 and a second resonant unit C2 connected in parallel to the second rectifier component D2, then the current flows through the voltage stabilization component C₀ and the load component R_{L} and flows through the first splitting component L1 and the second splitting component L2, so that half of the current flows back to the negative half-cycle output end, and the other half of the current flows to the second rectifier component D2 again for second conversion. In this way, because the first rectifier component D1 and the second rectifier component D2 are diodes, a merely allowed current path is from an alternating current end to a load end. Therefore, damages to an internal part caused by the current entering the cigar lighter 100 in a reverse direction can be avoided.

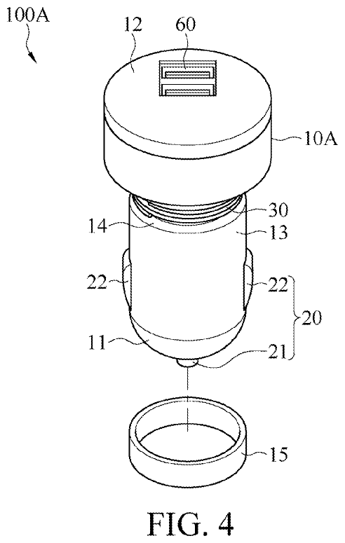

FIG. 4 is a partially exploded view of a second embodiment of a cigar lighter 100A according to the present invention. In this embodiment, a surface of a housing 10A has an annular groove 14, and a receive coil 30 is disposed around a second end 12 and disposed in the annular groove 14. Further, in this embodiment, the cigar lighter 100A further includes an insulation cover member 15. The insulation cover member 15 is disposed on the housing 10A to cover the receive coil 30. In addition, the insulation cover member 15 is made of an insulation material, so that the insulation cover member 15 does not affect receiving of a magnetic field by the receive coil 30 from the outside. In this way, the insulation cover member 15 is disposed to make the appearance of the cigar lighter 100A more beautiful without affecting receiving of the magnetic field. It should be noted that, this embodiment is an aspect in which the surface of the housing 10A has the annular groove 14 and the insulation cover member 15 is disposed on the housing 10A to cover the receive coil 30. However, the present invention is not limited thereto. Alternatively, the annular groove 14 and the insulation cover member 15 may be respectively applied to different embodiments.

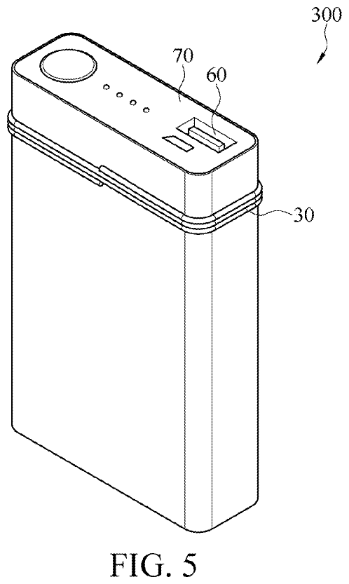

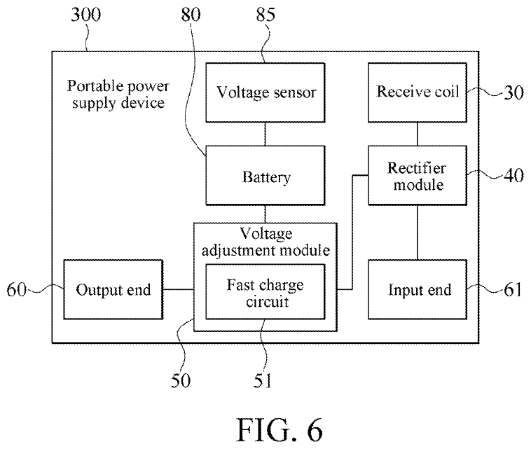

FIG. 5 and FIG. 6 are respectively a three-dimensional view and a circuit block diagram of an exemplary embodiment of a portable power supply device (which is referred to as a portable power supply device 300 for short below) having a wireless electricity receiving function according to the present invention. As shown in FIG. 5 and FIG. 6, the portable power supply device 300 includes a housing 70, a battery 80, a receive coil 30, a rectifier module 40, a voltage adjustment module 50, and an output end 60.

The portable power supply device 300 in one or more embodiments of the present invention is adapted to connect to a portable electronic device (for example, but is not limited to a smartphone, a notebook computer, a tablet computer, or a digital camera) by using a transmission cable. In this way, electricity of the battery 80 in the portable power supply device 300 may be provided to the portable electronic device in a direct current manner to charge the portable electronic device.

The portable power supply device 300 in one or more embodiments of the present invention is adapted to receive a magnetic field and supply power to the portable electronic device by using the transmission cable. When the portable power supply device 300 receives the magnetic field generated by a wireless charging station, the portable power supply device 300 may convert the magnetic field into a direct current and output the direct current to the portable electronic device by using the transmission cable to charge the portable electronic device.

Referring to FIG. 5 and FIG. 6, in this embodiment, the housing 70 is made of an insulation material (for example, but is not limited to plastic), to prevent a magnetic field generated by the receive coil 30 from interfering operation of an internal electronic part (such as the rectifier module 40 or the voltage adjustment module 50) of the portable power supply device 300. However, the present invention is not limited thereto. In some embodiments, only a part of the housing 70 that corresponds to the receive coil 30 may be made of an insulation material, and another part of the housing 70 may be made of an insulation material but is not limited thereto.

Referring to FIG. 5 and FIG. 6, the battery 80 is located in the housing 70 and may be adapted to provide an internal direct current to the voltage adjustment module 50. The receive coil 30 is disposed in the housing 70 and is adapted to generate an alternating current after receiving the magnetic field from the wireless charging station. In other words, the receive coil 30 may be disposed on the housing 70, embedded in the housing 70, or integrated with the housing 70 in a processing manner. In one or more embodiments, as shown in FIG. 5, the receive coil 30 is located on the housing 70 and disposed around the housing 70, that is, the housing 70 passes through the receive coil 30. However, the present invention is not limited thereto. In some embodiments, the receive coil 30 may alternatively be merely disposed on the housing 70 instead of being disposed around the housing 70.

The rectifier module 40 is located in the housing 70 and is electrically connected to the receive coil 30. The rectifier module 40 is adapted to receive and convert the alternating current into a first direct current. In other words, the rectifier module 40 may be a rectifier circuit and can convert the alternating current into the direct current. Specifically, two ends of the receive coil 30 may be inserted into the housing 70 and electrically connected to the rectifier module 40.

Referring to FIG. 5 and FIG. 6, the voltage adjustment module 50 is also located in the housing 70 and is electrically connected to the battery 80 and the rectifier module 40. The voltage adjustment module 50 is adapted to: selectively receive the internal direct current from the battery 80 and convert the internal direct current into a second direct current whose voltage is different from that of the internal direct current; or receive the first direct current from the rectifier module 40 and convert the first direct current into the second direct current whose voltage is different from that of the first direct current. In other words, the voltage adjustment module 50 may be a voltage adjustment circuit and is adapted to change the voltage. For example, the voltage of the internal direct current may be 12 V, the voltage of the first direct current may be 12 V, and the voltage of the second direct current may be 5 V.

Referring to FIG. 5 and FIG. 6, the output end 60 is electrically connected to the voltage adjustment module 50 to output the second direct current. The output end 60 may be, for example, but is not limited to a USB (universal serial bus) interface. The output end 60 may alternatively be another transmission interface such as an HDMI, a micro HDMI, or a micro USB interface, and may be adapted to connect to the portable electronic device.

According to the portable power supply device 300 in one or more embodiments of the present invention, after the receive coil 30 receives the magnetic field from the wireless charging station, the receive coil 30 converts the magnetic field into the alternating current through electromagnetic induction, and then the rectifier module 40 converts the alternating current into the first direct current. Then, the voltage adjustment module 50 converts the first direct current into the second direct current whose voltage is different from that of first direct current. Finally, the second direct current is output by using the output end 60. In this way, the portable electronic device may be connected to the output end 60 by using the transmission cable, to receive the second direct current from the portable power supply device 300 for being charged.

In one or more embodiments, referring to FIG. 6 again, the voltage adjustment module 50 of the portable power supply device 300 has a fast charge circuit 51, and the fast charge circuit 51 is a direct current voltage/current adjustment circuit having various fast charge protocol functions. For example, the fast charge circuit 51 may be a high-voltage fast charge circuit, a low-voltage fast charge circuit, or a voltage/current boost circuit. In other words, the fast charge circuit 51 may satisfy a fast charge protocol, so that the fast charge circuit 51 rapidly transmits the second direct current output from the output end 60 to the portable electronic device through voltage boosting, current boosting, or selective voltage/current boosting, to fast charge the portable electronic device.

Similarly, in one or more embodiments, the rectifier module 50 of the portable power supply device 300 may alternatively be the circuit shown in FIG. 3 and has the reverse blocking function; or the rectifier module 50 may include the circuit shown in FIG. 3, and details are not described herein again.

Further, in one or more embodiments, as shown in FIG. 6, the portable power supply device 300 may further include an input end 61, and the input end 61 is electrically connected to the rectifier module 50. The input end 61 is adapted to connect to an external power supply (such as mains). In this way, the rectifier module 40 may receive another alternating current from the external power supply and convert the another alternating current into a first direct current, and then the voltage adjustment module 50 converts the first direct current into a second direct current and provides the second direct current to the battery 80. In other words, the portable power supply device 300 may charge the battery 80 by using the input end 61. In some embodiments, the voltage adjustment module 50 is adapted to: after receiving the first direct current from the rectifier module 40, first store the first direct current to the battery 80, receive the first direct current from the battery 80 and convert the first direct current into the second direct current, and then provide the second direct current to the output end 60. That is, in some embodiments, after the alternating current is converted into the direct current and then a voltage of the direct current is changed, the voltage-changed direct current is stored to the battery 80 first, and then transmits to the output end 60 as required.

In addition, in one or more embodiments, when the portable power supply device 300 receives the magnetic field from the wireless charging station and the output end 60 of the portable power supply device 300 is connected to a portable electronic device, first it is determined whether a voltage of the battery 80 is less than a rated voltage (that is, the battery is in a state indicating a small electricity quantity). If yes, the voltage adjustment module 50 does not obtain the internal direct current (that is, does not receive the internal direct current) from the battery 80, but receives the first direct current from the rectifier module 40 and converts the first direct current into the second direct current, and transmits the second direct current to the output end 60 to charge the portable electronic device.

Specifically, in one embodiment, as described above, the voltage adjustment module 50 receives the internal direct current from the battery 80 and converts the internal direct current into the second direct current; or receives the first direct current from the rectifier module 40 and converts the first direct current into the second direct current. In an embodiment, the portable power supply device 300 further includes a voltage sensor 85 electrically connected to the battery 80 and adapted to sense whether the voltage of the battery 80 is less than the rated voltage (that is, sense whether the battery is in the state indicating a small electricity quantity). If yes, the voltage adjustment module 50 of the portable power supply device 300 receives the first direct current from the rectifier module 40 and converts the first direct current into the second direct current, and outputs the second direct current to the output end 60 to charge the portable electronic device. If not, the voltage adjustment module 50 of the portable power supply device 300 obtains the internal direct current from the battery 80, and then converts the internal direct current into the second direct current to provide the second direct current to the output end. If yes, the portable power supply device 300 receives an external direct current by using a first electric-conductor 21 and a second electric-conductor 22 and converts the external direct current into the second direct current. In this way, the portable power supply device 300 may first sense, by using the power supply sensor 85, whether an electricity quantity of the battery 80 is less than the rated voltage, and then determine, according to the result, to receive the internal direct current or the first direct current.

In conclusion, the cigar lighter and the portable power supply device in one or more embodiments of the present invention can convert a magnetic field into an alternating current through electromagnetic induction, and then further convert the alternating current into a direct current for outputting. In this way, when there is a wireless charging station that can provide a magnetic field, a user may connect a portable electronic device to the cigar lighter or the portable power supply device according to one or more embodiments of the present invention by using a transmission cable to receive a direct current, to charge the portable electronic device. In addition, in one or more embodiments, the voltage adjustment module satisfies a fast charge protocol because the voltage adjustment module has the fast charge circuit, to fast charge the portable electronic device. Moreover, the rectifier module may further include the reverse blocking circuit, to avoid a damage to an internal part caused because the current enters the device in a reverse direction.

Further, in one or more embodiments of the portable power supply device of the present invention, the voltage adjustment module is adapted to: after converting the first direct current into the second direct current, first store the second direct current to the battery, and then output the second direct current from the battery to the output end. In addition, in one or more embodiments of the portable power supply device of the present invention, when the voltage of the battery is less than the rated voltage, the voltage adjustment module does not receive the internal direct current but receives and converts the first direct current into the second direct current, and transmits the second direct current to the output end to charge the portable electronic device.

What is claimed is:

1. A cigar lighter having a wireless electricity receiving function, comprising:
a housing having a first end, a second end, and a chamber, wherein the first end is opposite to the second end;
a first electric-conductor located in the chamber and protruding from the first end;
a second electric-conductor located in the chamber and protruding from one side of the housing;
a receive coil located on the housing, wherein the receive coil is adapted to generate an alternating current after receiving a magnetic field;
a rectifier module located in the chamber, wherein the rectifier module is electrically connected to the receive coil, and the rectifier module is adapted to receive and convert the alternating current into a first direct current;
a voltage adjustment module located in the chamber, wherein the voltage adjustment module is electrically connected to the first electric-conductor, the second electric-conductor, and the rectifier module, and the voltage adjustment module is adapted to: selectively receive an external direct current by using the first electric-conductor and the second electric-conductor, and convert the external direct current into a second direct current; or receive the first direct current from the rectifier module and convert the first direct current into the second direct current, wherein a voltage of the external direct current is different from a voltage of the second direct current, and a voltage of the first direct current is different from the voltage of the second direct current; and
an output end located at the second end, wherein the output end is electrically connected to the voltage adjustment module to output the second direct current.

2. The cigar lighter having a wireless electricity receiving function according to claim 1, wherein the voltage adjustment module has a fast charge circuit.

3. The cigar lighter having a wireless electricity receiving function according to claim 1, wherein the receive coil is disposed around the second end.

4. The cigar lighter having a wireless electricity receiving function according to claim 3, wherein a surface of the housing has an annular groove, and the receive coil is disposed in the annular groove.

5. The cigar lighter having a wireless electricity receiving function according to claim 4, further comprising an insulation cover member, wherein the insulation cover member is disposed on the housing to cover the receive coil.

6. The cigar lighter having a wireless electricity receiving function according to claim 1, wherein the rectifier module is a reverse blocking circuit.

7. A portable power supply device having a wireless electricity receiving function, comprising:
a housing;
a battery located in the housing;
a receive coil disposed on the housing, wherein the receive coil is adapted to generate an alternating current after receiving a magnetic field;
a rectifier module located in the housing, wherein the rectifier module is electrically connected to the receive coil, and the rectifier module is adapted to receive and convert the alternating current into a first direct current;
a voltage adjustment module located in the housing, wherein the voltage adjustment module is electrically connected to the battery and the rectifier module, and the voltage adjustment module is adapted to: selectively receive an internal direct current from the battery and convert the internal direct current into a second direct current, or receive the first direct current from the rectifier module and convert the first direct current into the second direct current, wherein a voltage of the internal direct current is different from a voltage of the second direct current, and a voltage of the first direct current is different from the voltage of the second direct current; and
an output end electrically connected to the voltage adjustment module to output the second direct current.

8. The portable power supply device having a wireless electricity receiving function according to claim 7, wherein the voltage adjustment module has a fast charge circuit.

9. The portable power supply device having a wireless electricity receiving function according to claim 7, wherein the rectifier module is a reverse blocking circuit.

10. The portable power supply device having a wireless electricity receiving function according to claim 7, wherein the voltage adjustment module is adapted to: after converting the first direct current into the second direct current, first store the second direct current to the battery, and then output the second direct current from the battery to the output end.

11. The portable power supply device having a wireless electricity receiving function according to claim 7, wherein when a voltage of the battery is less than a rated voltage, the voltage adjustment module does not receive the internal direct current but receives and converts the first direct current into the second direct current.
